(19) United States
(12) Patent Application Publication
(10) Pub. No.: US 2026/0340700 A1
(43) Pub. Date: Oct. 29, 2026

(54) Presenting an Assembly Incorporating an Individually Unavailable Component Part

(71) Applicant: eBay Inc., San Jose, CA (US)

(72) Inventors: Andrew Chalkley, Milwaukie, OR (US); Dmitry Paskalov, Cliffside Park, NJ (US)

(73) Assignee: eBay Inc., San Jose, CA (US)

(21) Appl. No.: 19/191,336

(22) Filed: Apr. 28, 2025

(51) Int. Cl. G06Q 30/0601

(52) U.S. Cl. CPC G06Q 30/0627; G06Q 30/0641

(57) ABSTRACT

Presenting an assembly incorporating an individually unavailable component part is described. In one or more implementations, a computing device receives search results indicating that a component part of an item is unavailable on an online marketplace. Responsive to the unavailability, the computing device identifies one or more assemblies incorporating the component part. The computing device searches listings of the online marketplace based on one or more supplemental search queries generated for the identified assemblies. A user interface is caused to present at least one listing of the online marketplace for an assembly incorporating the component part.

### BACKGROUND

When component parts of an item break or fail, it can cause significant challenges, both in restoring functionality and finding a replacement. The failure of a single component can often render the entire item inoperative, despite the majority of the item's parts being intact and functioning properly. Identifying and sourcing the exact replacement part can be difficult due to limited availability, especially for older, proprietary, or specialized items. Further complications arise from vague product descriptions, inconsistent naming conventions, and lack of standardization in part numbers, making it hard to confirm compatibility.

### SUMMARY

To address these issues, identifying and presenting an assembly incorporating an individually unavailable component part is leveraged by an online marketplace. Responsive to a search query for a component part of an item, search results are received which indicate that the component part is unavailable as a standalone item on the online marketplace. In response, a system identifies assemblies that incorporate the unavailable component part. The system then searches listings of the online marketplace using supplemental search queries generated for the identified assemblies, e.g., by a large language model. A user interface, e.g., of an application of the online marketplace, can then present at least one listing for an assembly that incorporates the originally sought component part. This allows users to find and purchase larger assemblies containing a needed part when the individual part itself is not available on the online marketplace. The system may rank the identified assemblies and present a highest-ranked option or sort the listings presented based on the rankings. Rankings can consider factors like assembly cost, disassembly difficulty, and installation complexity. Assembly identification can leverage repositories of parts lists or hierarchical tree structures defining item structures.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of an unavailable component part system in further detail.

FIG. 3 depicts an example of a browsing user interface of an online marketplace that includes an interactive search user interface element.

FIG. 4 depicts an example of a search results user interface of an online marketplace.

FIG. 5 depicts an example of an interactive ranking user interface element being displayed from a search results user interface of an online marketplace.

FIG. 6 depicts a procedure in an example implementation of presenting an assembly incorporating an individually unavailable component part.

FIG. 7 illustrates an example of a system that includes an example of a computing device which is representative of one or more computing systems and/or devices that may implement the various techniques described herein.

### DETAILED DESCRIPTION

### Overview

Online marketplaces are used for purchasing a wide variety of items, including component parts for repairs or replacements. However, conventional approaches to finding specific component parts on these platforms often fall short when the exact part sought is unavailable as a standalone item. Users searching for a particular component part of an item may encounter frustrating dead ends, leaving them unable to complete necessary repairs or upgrades. Traditional search methods typically rely on exact matches or basic keyword associations, which can be ineffective when dealing with complex assemblies or specialized parts. This limitation often results in users abandoning their search or resorting to purchasing entirely new items, leading to unnecessary expenses and potential waste.

To address these challenges, identifying and presenting an assembly which incorporates an individually unavailable component part is leveraged. When a user searches for a component part that is unavailable on its own, the system identifies assemblies that incorporate the desired part. This process involves analyzing comprehensive repositories of parts lists and assembly tree structures to locate relevant assemblies.

In at least one implementation, the system generates supplemental search queries based on the identified assemblies, allowing for a more thorough exploration of available listings than an original search query for the component part. These supplemental search queries are formulated using a large language model (LLM). By way of example, the LLM has been fine-tuned on the repository of parts lists and/or assembly tree structures. This approach enables the system to understand complex relationships between components and assemblies, even across different types of items.

Once assemblies incorporating the component part are identified, the system presents listings for these assemblies to the user through an intuitive user interface, such as via a user interface of an application of an online marketplace and/or via a web page presented via a web browser. To further assist users in making informed decisions, the assemblies can be ranked and sorted in the user interface based on various criteria such as cost, difficulty of disassembly, and/or ease of installation. This ranking functionality helps users quickly identify the most suitable option for their specific needs and capabilities.

In addition to presenting assembly listings, the system can provide detailed instructions for disassembling the assembly to obtain the desired component part or for installing the part once acquired. This guidance enhances the user's ability to successfully complete their repair or replacement task. In at least one variation, the system also incorporates the ability to identify and suggest compatible parts when the exact component part is unavailable on the online marketplace. This feature expands the range of potential solutions, increasing the likelihood of finding a suitable replacement part.

This approach improves upon conventional systems for finding component parts. For example, the described techniques transform what was often a frustrating and unproductive experience when a component part was unavailable into a more successful process, e.g., automatically providing alternative options to the individual component part when unavailable. Users benefit from those increased options, as well as from potentially lower costs and improved guidance throughout their search and subsequent repair or replacement tasks. Not only does this solution enhance the user experience but it also promotes sustainability by facilitating repairs and reducing the need for complete item replacements. Further, this is a significant step forward in making online marketplaces more effective and user-friendly for those seeking specific component parts.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

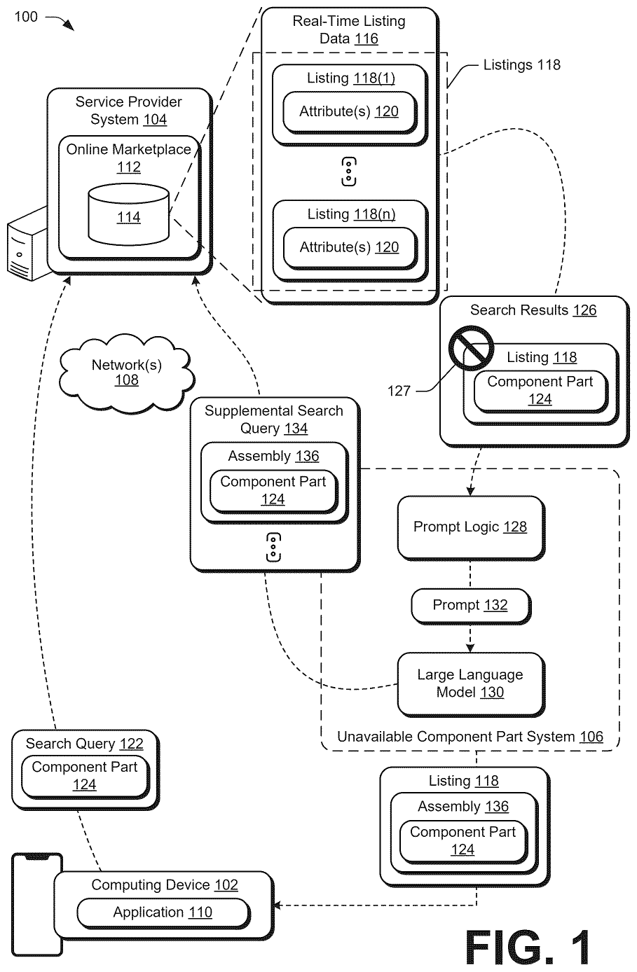

FIG. 1 is an illustration of an environment 100 in an example implementation that is operable to employ techniques described herein. The environment 100 includes a computing device 102, a service provider system 104, and an unavailable component part system 106. In one or more implementations, the computing device 102, the service provider system 104, and the unavailable component part system 106 are communicatively coupled, one to another, via network(s) 108. One example of the network(s) 108 is the Internet, although one or more of the computing device 102, the service provider system 104, and the unavailable component part system 106 may be communicatively coupled using one or more different connections or different networks in various implementations.

Although the unavailable component part system 106 is depicted in the environment 100 as being separate from the computing device 102 and the service provider system 104, in one or more implementations, an entirety or various portions of the unavailable component part system 106 are implemented at or by the computing device 102 and/or the service provider system 104. In at least one implementation, for example, at least a portion of the unavailable component part system 106 is implemented by an application 110 of the computing device 102 and/or using various resources of the computing device 102, such as hardware resources, an operating system, firmware, and so forth. Alternatively or additionally, at least a portion of the unavailable component part system 106 is implemented by resources (e.g., server-based storage, processing, and so on) of the service provider system 104. Alternatively, or additionally, at least a portion of the unavailable component part system 106 is implemented using a third-party service, such as a web services platform that provides one or more hardware and/or other computing resources to support provision of services by web service providers.

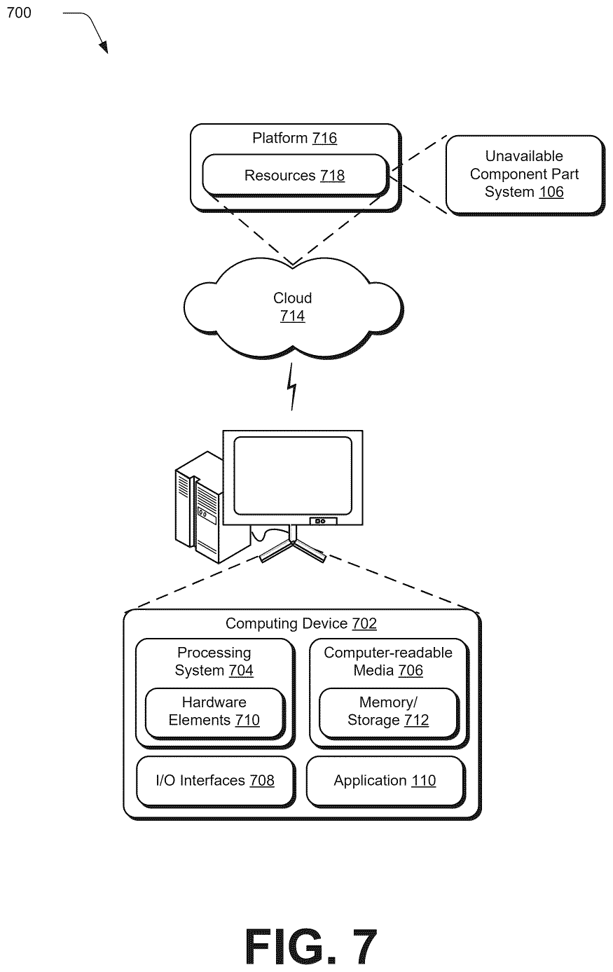

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 7.

In at least one implementation, the application 110 supports communication of data across the network(s) 108, such as between the computing device 102 and the service provider system 104 and/or between the computing device 102 and the unavailable component part system 106. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, and facilitate user interaction with web pages of the online marketplace 112's website. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings for items and to expose those listings (e.g., publish them) across the network(s) 108 to one or more computing devices, including to the computing device 102. For example, the online marketplace 112 may generate listings for items for sale and expose those listings to computing devices, such that users of the computing devices can interact with the listings via user interfaces to initiate transactions (e.g., purchases, add to wish lists, share, and so on) in relation to the respective item or items of the listings. In accordance with the described techniques, the online marketplace 112 is configured to generate listings for one or more types of physical goods or property (e.g., clothing and/or clothing accessories, collectibles, furniture, decorative items, textiles, luxury items, electronics, real property, physical computer-readable storage having one or more video games or other digital content stored thereon, automotive parts, and so on), services (e.g., babysitting, dog walking, house cleaning, home repair, general contracting, auto servicing, and so on), digital items (e.g., digital images, digital music, digital videos) that can be downloaded via the network(s) 108, and blockchain backed assets (e.g., non-fungible tokens (NFTs)), to name just a few.

In the illustrated environment 100, the online marketplace 112 includes storage device 114, which is depicted maintaining real-time listing data 116. The real-time listing data 116 includes listings of the online marketplace 112. Examples of such listings include listing 118(1) and listing 118(n), where ‘n’ represents any integer number greater than or equal to 2.

The storage device 114 may represent one or more databases and/or other types of storage capable of storing the real-time listing data 116. Examples of the storage device 114 include, but are not limited to, mass storage and virtual storage. In one or more implementations, for example, the storage device 114 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed in to such an account or tracked as a user with an account.

In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items thereon. For instance, a number (e.g., most) of the users of the online marketplace 112 may not be employed by or otherwise similarly controlled by a company associated with the online marketplace 112. In this way, the users of the online marketplace 112 may exert more control over the items listed with the online marketplace 112 (e.g., the items that those users decide to list through the online marketplace 112) than the company associated with the online marketplace 112 (or its employees or agents).

Users that cause items to be listed on the online marketplace 112 may be referred to as “sellers,” whereas users that purchase or otherwise obtain items listed on the online marketplace 112 via its listings may be referred to as “buyers.” Sellers and buyers both interact with user interfaces of the online marketplace 112 (e.g., via the application 110) to perform the desired functionality. In addition, an individual user of the online marketplace 112 can interact via the interfaces to be both a seller and a buyer on the online marketplace 112, such as by interacting with the user interfaces to have caused one or more items to be listed on the online marketplace 112 and by interacting with the user interfaces to purchase one or more items from the listings of the online marketplace 112.

A user that is a seller, for instance, may interact with one or more user interfaces of the online marketplace 112 (e.g., output via the application 110) to provide information about one or more items which the user is causing to be listed on the online marketplace 112. Such user interfaces may include prompts that instruct, or guide, users that are sellers to provide various information about items being listed. Examples of information that such interfaces prompt sellers for and that those users provide include but are not limited to a title, description (of the item), one or more prices (e.g., to purchase the item now and/or a minimum starting bid for the item), brand information, size, year, color(s), shipping information (e.g., cost and/or types available), delivery information, return information, payment information, images, videos, models, authenticity information, item history (e.g., chain of custody), and condition (of the item), to name a few.

One or more portions of such information may be referred to herein as attribute(s) 120 of the listing. For example, a title of the listing may be an attribute of the listing, a description of the item being listed may be an attribute of the listing, one or more images uploaded or selected for the listing may be one or more attributes of the listing, color(s) of the item may be an attribute of the listing, a category of the item may be an attribute of the listing, and so forth.

Broadly, the described techniques provide a solution to scenarios where a user searches the online marketplace 112 for a component part of an item and where the component part is unavailable as a standalone part on the online marketplace. In one or more implementations, a user of the computing device 102 causes a search query 122 for a component part 124 to be communicated by the computing device 102 over the network(s) 108 and received by the online marketplace 112. For example, the user interacts with an interactive search user interface element displayed by the application 110 via a display of the computing device 102 to submit the search query 122 for the component part 124. Responsive to receiving the search query 122, the online marketplace 112 is configured to search the listings 118 in an attempt to find a listing for the component part 124. For instance, the online marketplace 112 utilizes a search engine (e.g., of the online marketplace 112 or of a third party) to search the real-time listing data 116 for any listings 118 for the component part 124.

As mentioned above, however, the described techniques relate to scenarios where the component part 124 is unavailable by itself at the online marketplace 112. In other words, the online marketplace 112 determines that there are no listings available in the real-time listing data 116 for only the component part 124. Alternatively, the online marketplace 112 determines that there are no listings available to provide to the particular user of the computing device 102 for only the component part 124. As a result of this unavailability, the unavailable component part system 106 receives search results 126 indicating that listings 118 for the component part 124 are unavailable on the online marketplace 112. In at least one implementation, the search results 126, which indicate that no such listings 118 are available, are provided to the unavailable component part system 106 by a search engine and/or search module of the online marketplace 112. The general prohibition sign 127 or “no sign” is included with the search results 126 to indicate that there are no listings 118 for the component part available at the online marketplace 112. Alternatively or additionally, such search results may be provided to the unavailable component part system 106 by a third-party search engine. In one or more implementations, the failure to find such an available listing at the online marketplace 112 triggers the unavailable component part system 106 to identify alternative listings for responding to the search query 122.

Alternatively or additionally, the unavailable component part system 106 may be triggered when the component part 124 is listed individually on the online marketplace 112, but certain conditions make it less desirable or impractical to provide a listing for the individually listed component part 124 to the user. For instance, if the price of the individually listed component part 124 exceeds a predetermined threshold or is significantly higher than a historical average price for that part, the system may consider the component part 124 effectively unavailable. In such cases, the unavailable component part system 106 may initiate the process of identifying assemblies 136 that incorporate the component part 124 or identifying compatible parts, potentially offering a more cost-effective solution to the user.

Another scenario that may trigger the unavailable component part system 106 is when the shipping time or availability of the individually listed component part 124 does not meet a user's needs. For example, if the estimated delivery time for the component part 124 is excessively long, or if the component part is backordered with an uncertain availability date, the system may treat the component part as unavailable for practical purposes. In these situations, the unavailable component part system 106 may search for assemblies 136 that include the desired component part 124 (or for compatible parts) and that are available for faster shipping or immediate pickup, thereby providing alternative options that better align with a user's timeline or urgency.

In at least implementations, the unavailable component part system 106 may be triggered by various other conditions or user preferences. For example, the system may be activated when: the individually listed component part 124 does not meet specific quality or condition requirements set by the user; a seller's reputation or rating falls below a certain threshold, potentially raising concerns about the reliability of the transaction; the component part 124 is available but incompatible with the user's specific model or version of the item; the warranty or return policy for the individual component part 124 is less favorable compared to purchasing a complete assembly; the user's search history or profile indicates a preference for DIY (do it yourself) repairs, suggesting they may be open to purchasing and disassembling larger assemblies; or the geographical location of the individual component part 124 makes shipping costs prohibitively expensive, while a local seller may offer an assembly containing the desired part.

In accordance with the described techniques, the unavailable component part system 106 is tasked with identifying alternative listings for responding to the search query 122, such as listings for assemblies that incorporate the component part 124 and/or listings for parts that are compatible with the component part 124. In at least one example, the unavailable component part system 106 includes or otherwise has access to prompt logic 128 and a large language model 130, which is also referred to commonly and may be referred to herein as an “LLM.” Although referenced throughout as simply “large language model 130,” in one or more implementations, the large language model 130 may be or include one or more LLMs (e.g., text-to-text LLMs), multi-modal LLMs, LLM agents, and so forth. As discussed below, a multi-modal LLM has an architecture and is trained to convert between textual data and at least one other form of data, such as image, audio, and/or video, examples of which include text-to-image LLMs and image-to-text LLMs and which may be referred to as vision language models. Broadly, LLM agents combine at least one LLM with retrieval (e.g., retrieval-augmented generation or “RAG” to access real-time data), reasoning (e.g., by using advanced prompting techniques that guide the agent on how to make decisions), memory (e.g., short-term memory of recent conversations, long-term memory to store structured information, and task specific recall), and tool use (e.g., the ability to interact with any of a variety of external systems to obtain data or perform actions), to autonomously complete tasks. It is to be appreciated that the unavailable component part system 106 may include more, different, or fewer components in variations.

In one or more implementations, the prompt logic 128 is configured to generate a prompt 132 to elicit the large language model 130 (LLM) to generate at least one supplemental search query 134 for an assembly 136 that incorporates the component part 124. Additionally, or alternatively, the prompt 132 elicits the large language model 130 to identify one or more assemblies that incorporate the component part 124, and, subsequent to the identification, generate supplemental search queries based on the identified assemblies. In at least one example, the prompt 132 is configured to elicit the large language model 130 to generate multiple supplemental search queries 134, where each such search query specifies a different assembly 136 that incorporates the component part 124.

In one or more implementations, a supplemental search query 134 may be a refined or expanded search query generated by the large language model 130 in response to the prompt 132. Unlike the initial search query 122 submitted by the user, which may be focused solely on the component part 124, the supplemental search query 134 is designed to identify assemblies 136 that incorporate the desired component part, such as within other assemblies. This expanded scope allows the system to find relevant listings for such other assemblies even when the specific component is not available as a standalone item. For instance, the supplemental search query 134 may query the online marketplace 112 to search for the identified assembly or assemblies rather than for the component part. By way of example, a supplemental search query 134 may not specify the component part (e.g., in a text string or query image), but rather one or more identified assemblies.

The supplemental search query 134 differs from the prompt 132 in that the prompt is an instruction or request given to the large language model 130, while the supplemental search query is the output generated by the model in response to that prompt. The prompt 132 may contain contextual information, specific instructions, or parameters that guide the large language model 130 in formulating the supplemental search query 134. For instance, the prompt may instruct the model to consider various attributes of the component part, potential assemblies that the component part might be included in, or relevant product categories, to name just a few.

In at least one implementation, the content of the supplemental search query 134 varies depending on factors such as the specificity of the initial search query 122 and a user's historical data. In cases where the initial query is highly specific, and it includes details like exact model numbers or technical specifications, the supplemental search query 134 may be more targeted, focusing on assemblies that precisely match those specifications. Conversely, for broader initial queries, the supplemental search query 134 may explore a wider range of potential assemblies. When historical data indicates a user's preference for certain types of assemblies or brands, the supplemental search query 134 may be tailored to prioritize those preferences, potentially including terms or filters that align with the user's past purchasing behavior. This adaptive approach allows the system to generate supplemental search queries 134 that are not only relevant to the sought-after component part but also personalized to the user's needs and preferences.

In a scenario where the large language model 130 generates a single supplemental search query 134, the online marketplace 112 receives the supplemental search query 134 and causes the real-time listing data 116 to be searched for the assembly 136, specified in the supplemental search query 134 which incorporates the component part 124. For example, a search engine or search module (e.g., of the online marketplace 112) is provided the supplemental search query 134 and searches the real-time listing data 116 for the assembly 136. In the scenario where the large language model 130 generates multiple supplemental search queries 134, the online marketplace 112 receives the multiple supplemental search queries 134 and causes the real-time listing data 116 to be searched for each of the different assemblies, specified in the respective supplemental search queries 134 which incorporate the component part 124.

Based on the search, at least one listing 118 is returned for an assembly 136 that incorporates the component part 124. For example, the online marketplace 112 (e.g., a search engine or search module) returns at least one listing 118 for an assembly 136 which incorporates the component part 124 to the computing device 102. Alternatively, or additionally, the unavailable component part system 106 returns the at least one listing 118 for the assembly 136 which incorporates the component part 124 to the computing device 102. In accordance with the described techniques, the listings 118 for the assembly 136 incorporating the component part 124 are presented via a user interface. For example, the application 110 causes the computing device 102 to display a user interface which includes the listing 118 for the assembly 136 incorporating the component part 124.

By identifying assemblies 136 that incorporate an individually unavailable component part 124, users can obtain the desired part when it is unavailable as a standalone item on the online marketplace 112. This approach may expand the options available to users, allowing them to find solutions even when individual parts are not listed as standalone items. Additionally, the use of a large language model 130 to generate supplemental search queries 134 may enhance the system's ability to identify relevant assemblies 136, potentially uncovering options that users might not have considered when formulating a search query. The presentation of assembly listings 118 incorporating the desired component part 124 may save users time and effort in their search, and could potentially lead to cost savings if purchasing an entire assembly 136 is more economical than sourcing an individual part. Furthermore, the described techniques may help extend the lifespan of products by facilitating repairs or replacements of specific components, even when those components are not readily available as standalone items in the online marketplace 112 or from other entities.

In addition to providing alternate options for procuring individually unavailable component parts, the unavailable component part system 106 is also configured to assist a user searching for the component part 124 in selecting from among multiple listings of assemblies 136 presented via a user interface, e.g., of the application 110. In at least one implementation, for example, the unavailable component part system 106 is configured to rank identified assemblies 136 based on one or more criteria and cause a user interface (e.g., of the application 110) to present at least one listing of an assembly based on the ranking. For instance, the unavailable component part system 106 causes the user interface to present a listing of a highest-ranked assembly. Additionally or alternatively, the unavailable component part system 106 causes the user interface to present listings of multiple assemblies 136 which include the component part 124 in a ranked order, such as a highest-ranked assembly being presented first (at a top), a second highest-ranked assembly being presented second (just below the highest-ranked assembly), and so forth.

It is to be appreciated that the unavailable component part system 106 may rank the assemblies 136 based on any one or more of a variety of criteria, examples of which include but are not limited to: cost of an identified assembly 136 incorporating the component part 124, cost to disassemble an identified assembly 136 and have the component part 124 installed by a technician (e.g., a mechanic for installing an automotive or other vehicular part in or on a vehicle), difficulty of disassembling an identified assembly 136 to obtain the component part 124 from the assembly before installing the component part 124 in or on the item for which the component part 124 is sought, difficulty of installing the identified assembly 136 or component part 124 in the item, a weighted combination of any one or more of these or other criteria (a “best match”), and so on. In variations, additional or different criteria may be used to rank the assemblies 136.

With regard to the ranking criterion which relates to having the component part 124 installed by a technician (e.g., a mechanic or other type of installer), in one or more scenarios, such a technician may be an agent of the online marketplace 112 or an agent of a third party. In at least one implementation, the online marketplace 112 may provide optional recommendations for technicians as part of the listings for component parts or compatible parts, such as via a user interface presenting those listings. As such, the recommendation for a technician may be selectable to “Add to Cart” for purchase along with or separately from adding the listed item to the cart for purchase.

In one or more implementations, the user interface via which one or more of the assemblies 136 are presented also includes an interactive element that is selectable to enable a user to select which one or more criteria to use to rank the presented listings of the assemblies 136. Additionally, or alternatively, the interactive ranking elements are configured for interaction to rank the listings from low to high or high to low, such as from lowest to highest cost, from highest to lowest cost, from highest to lowest difficulty of disassembling the assembly 136 to obtain the component part 124, from lowest to highest difficulty of disassembling the assembly 136 to obtain the component part 124, and so on. The unavailable component part system 106, e.g., the large language model 130, may determine these rankings based on analyzing a repository of parts lists, assembly tree structures, and/or assembly instructions for assembling and/or disassembling an assembly.

By way of example, the large language model 130 may analyze repositories of parts lists, assembly tree structures, and/or assembly instructions to rank the identified assemblies 136 in various ways. For instance, the large language model 130 may process and interpret textual and structured data from these sources to extract relevant information for ranking criteria. For parts lists, the large language model 130 may identify component relationships, quantities, and hierarchies. The large language model 130 may recognize patterns in part naming conventions and categorizations, allowing the large language model 130 to understand which components are typically found in specific assemblies 136.

When analyzing assembly tree structures, the large language model 130 may interpret the hierarchical relationships between components, sub-assemblies, and full assemblies. This understanding of the hierarchical relationships may help in assessing the complexity of disassembly or the number of steps required to access a particular component part 124. As mentioned above, the large language model 130 may be or include one or more LLM agents. By way of example, the large language model 130 may include an LLM agent configured to search one or more types of assembly tree structures and interpret the above-noted relationships. The additional features of LLM agents, including retrieval, reasoning, memory, and tool use, which are combined with one or more LLMs, may make them particularly suited for analyzing tree-based data hierarchies.

For assembly instructions, the large language model 130 may process natural language descriptions of assembly and disassembly procedures. The large language model 130 may identify key phrases indicating difficulty levels, required tools, number of components, number of steps, and/or time estimates for various steps. The large language model 130 may also recognize warnings or cautions that suggest increased complexity or risk in certain procedures.

By combining insights from these sources, the large language model 130 may generate composite scores for different ranking criteria. For example, the large language model 130 may estimate disassembly difficulty by considering the number of steps in the instructions, the depth of the component part 124 in the assembly tree structure 208, and any specialized tools mentioned. The large language model 130 may also learn to associate certain patterns or features with user-reported difficulty levels or cost estimates, allowing the large language model 130 to make predictions for new or unfamiliar assemblies 136. For example, the large language model 130 may identify similarities between assemblies 136 to infer rankings for items with limited available information. Additionally, the large language model 130 may be capable of processing images or diagrams often included in assembly instructions, extracting visual cues that contribute to ranking factors such as installation complexity. For instance, the large language model 130 may be or include a multi-modal large language model, having an architecture and trained to interpret between textual data and at least one other form of data, such as image, audio, and/or video. One example of multi-modal large language model is a vision language model, which can understand and process both visual and textual information, bridging the gap between computer vision and natural language processing. As the large language model 130 analyzes more data over time, the large language model 130 may refine its ranking algorithms, potentially identifying subtle factors that influence assembly 136 complexity or cost that may not be immediately apparent to human analysts.

By offering users the ability to select to rank and sort assemblies 136 incorporating the desired component part, 124 the unavailable component part system 106 may enhance user experience and decision-making. The variety of example ranking criteria, such as cost, difficulty of disassembly, and installation complexity, may allow users to prioritize factors most relevant to their specific needs and capabilities. This customizable approach may save users time and effort in evaluating multiple options. Additionally, the interactive ranking elements may provide flexibility, allowing users to dynamically adjust their view of the search results based on changing priorities or to compare different ranking scenarios. By presenting assemblies in a ranked order, with options to sort from high to low or low to high, the system may help users quickly identify the most suitable assembly for their particular situation, whether they are prioritizing cost-effectiveness, ease of installation, or a balance of multiple factors. This ranking functionality may complement the system's ability to identify assemblies containing unavailable component parts, potentially increasing the likelihood of users finding a viable solution to their component part needs.

Having considered an example of an environment, consider now a discussion of some example details of the techniques for presenting an assembly incorporating an individually unavailable component part in accordance with one or more implementations.

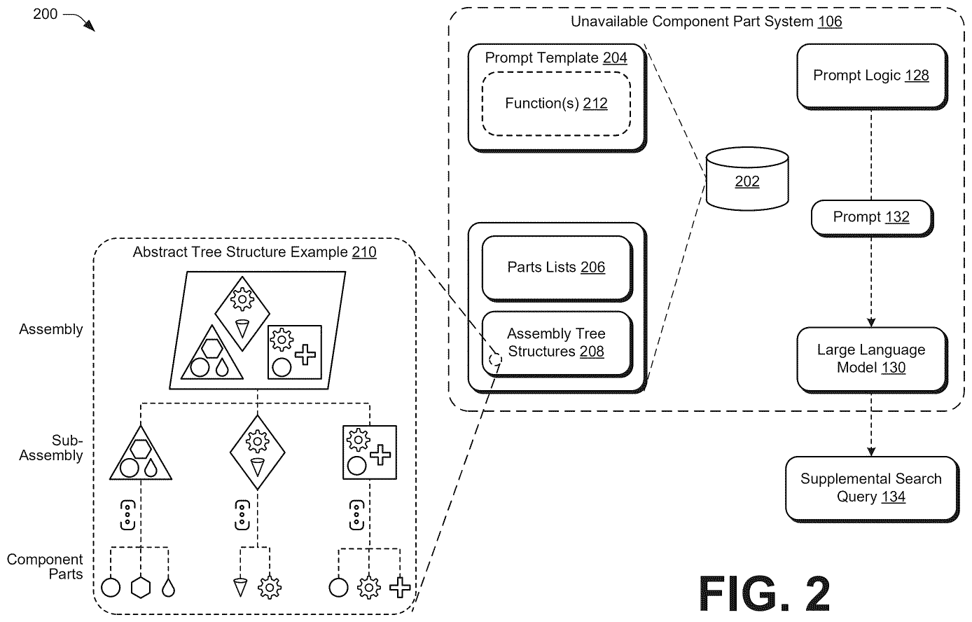

FIG. 2 depicts an example 200 of an unavailable component part system in further detail.

In particular, FIG. 2 depicts an example of the unavailable component part system 106 in detail. In this example 200, the unavailable component part system 106 includes the prompt logic 128 and the large language model 130. Additionally, the unavailable component part system 106 is depicted including a storage device 202, which is shown maintaining a prompt template 204, parts lists 206 (e.g., the storage device 202 may serve as a repository of parts lists in one or more implementations), and assembly tree structures 208. In one or more implementations, the storage device 202 is configured in a similar manner to the storage device 114 discussed above. In at least one implementation, the storage device 202 is included in or is part of the storage device 114.

In one or more implementations, the prompt logic 128 may generate the prompt 132 using the prompt template 204. The prompt template 204 may include a predefined structure with placeholders for various elements, such as the component part 124 being searched for. Additionally, or alternatively, the prompt template 204 may include placeholders for other elements, such as a type or category of item the component part 124 belongs to and specific instructions for the large language model 130. When generating the prompt 132, the prompt logic 128 may populate these placeholders with relevant information extracted from the search query 122 and other contextual data, such as identified compatible parts to the component part 124.

The prompt template 204 may also include one or more functions 212 that can be dynamically modified based on the specific component part 124 and a context of the search. These functions 212 may instruct the large language model 130 on how to search and analyze the parts lists 206 and assembly tree structures 208. For example, a function 212 may direct the large language model 130 to traverse the assembly tree structures 208 to identify assemblies that contain the component part 124 at any level of the hierarchy.

In one or more implementations, the prompt logic 128 may customize the prompt 132 based on the specificity of the search query 122. If the search query 122 includes detailed information about the component part 124, such as its exact model number or specifications, the prompt logic 128 may generate a more targeted prompt 132 that instructs the large language model 130 to perform a precise search within the parts lists 206. Conversely, if the search query 122 is more general, the prompt logic 128 may generate a broader prompt 132 that encourages the large language model 130 to explore a wider range of potential assemblies 136 that might incorporate similar or compatible parts.

As discussed above and below, the unavailable component part system 106 may generate supplemental search queries to identify compatible parts rather than, or in addition to, identifying assemblies that incorporate the specific component part 124. When generating a supplemental search query for compatible parts, the large language model 130 may analyze the parts lists 206 and assembly tree structures 208 to identify parts with similar specifications, functionality, or compatibility with the item for which the component part 124 is intended. The prompt 132 provided to the large language model 130 may include instructions to focus on attributes such as dimensions, material properties, performance characteristics, and compatibility with specific models or brands. The resulting supplemental search query 134 may include terms related to these attributes, as well as alternative part numbers or categories that encompass potential compatible parts.

In contrast, when generating a supplemental search query for assemblies that include the component part 124, the large language model 130 may focus on identifying larger units or assemblies that typically incorporate the specific component part 124. The prompt 132 in this case may instruct the large language model 130 to analyze the assembly tree structures 208 to identify parent assemblies or products that contain the exact component part 124 as a subcomponent. The resulting supplemental search query may include terms related to these larger assemblies, their functions, or the categories of products they belong to. While a supplemental search query for a compatible part may emphasize similarity and interchangeability, a supplemental search query for an assembly that incorporates the component part may prioritize the identification of complete units or subassemblies that contain the exact component part 124 or its close equivalents.

The prompt logic 128 may also incorporate historical data and user preferences into the prompt generation process. For instance, if a user has previously searched for similar component parts or has a history of purchasing certain types of assemblies, the prompt logic 128 may adjust the prompt 132 to prioritize searches within relevant categories or brands. This personalized approach may enhance the relevance of the supplemental search queries 134 generated by the large language model 130, potentially leading to more accurate and useful results for the user.

The parts lists 206 and assembly tree structures 208 may serve as comprehensive repositories of information about various assemblies and their constituent components. These data structures may be organized in a manner that facilitates efficient searching and analysis by the large language model 130. The parts lists 206 may contain detailed information about individual components of assemblies, including their specifications, compatibility, and relationships to other parts within those assemblies. The assembly tree structures 208 may represent the hierarchical organization of assemblies, sub-assemblies, and individual components, providing a view of how different parts relate to each other within an overall assembly.

In at least one implementation, the large language model 130 may utilize the parts lists 206 and the assembly tree structures 208 to identify assemblies that incorporate the component part 124. The model may traverse the assembly tree structures 208, analyzing the hierarchical relationships between components to locate assemblies that include the desired part at any level of the structure. This process may involve matching the specifications of the component part 124 with the detailed information provided in the parts lists 206, allowing the model to identify not only exact matches but also potentially compatible alternatives.

In one or more implementations, the large language model 130 is fine-tuned using the information included in the parts lists 206 and the assembly tree structures 208. This fine-tuning process may involve training the large language model 130 on the specific vocabulary, naming conventions, and structural relationships present in these data sources after the large language model is generically trained on a vast array of sources, such as on a large corpus of information like the “Pile.” By exposing the large language model 130 to a wide range of assembly configurations and part relationships, the large language model 130 may develop a nuanced understanding of how different components typically fit together within various types of assemblies.

In some cases, the large language model 130 may use its understanding of assembly structures gained through fine-tuning to identify assemblies from different items that incorporate the component part 124. For example, if a user is searching for a specific gear for a kitchen appliance, the large language model 130 may identify that the same or a compatible gear is used in a different type of device, such as a power tool. This cross-referencing capability may be enabled by the large language model 130's ability to recognize similarities in part specifications and assembly structures across different categories of items.

The fine-tuning may also enhance the large language model 130's ability to interpret and generate natural language descriptions of assemblies and their components. This may allow the large language model 130 to more accurately process user queries that use non-technical language or imprecise descriptions of parts. Additionally, the fine-tuning may enable the large language model 130 to generate more informative and user-friendly descriptions of identified assemblies and the steps required to access or replace specific components.

In some implementations, the large language model 130 may use its understanding of assembly structures gained through fine-tuning to estimate a difficulty or complexity of accessing or replacing the component part 124 within an item. This assessment may be based on factors such as the depth of the component part within the assembly tree structure, a number of other components that need to be removed to access the component part, and any special tools or procedures required for disassembly. Such insights may be valuable for ranking and presenting assembly options to users based on their skill level or resources.

The large language model 130's analysis of the parts lists 206 and assembly tree structures 208 may also extend to identifying patterns in how components are typically grouped or associated within assemblies. This understanding may allow the large language model 130 to make intelligent suggestions for additional parts or tools that might be necessary or beneficial when replacing a specific component, potentially improving the user's ability to successfully complete a repair or replacement task.

The tree structure example 210 illustrates a hierarchical relationship between assemblies, sub-assemblies, and component parts, with each level branching into more specific elements. At the top level, an assembly may be composed of multiple sub-assemblies, which in turn may contain their own sub-assemblies and/or individual component parts. The use of ellipses within the tree structure suggests that there may be multiple levels of sub-assemblies between the top-level assembly and the individual component parts, allowing for complex nested relationships in the hierarchy. Alternatively, or additionally, an assembly may be formed of only component parts with no intermediate sub-assemblies.

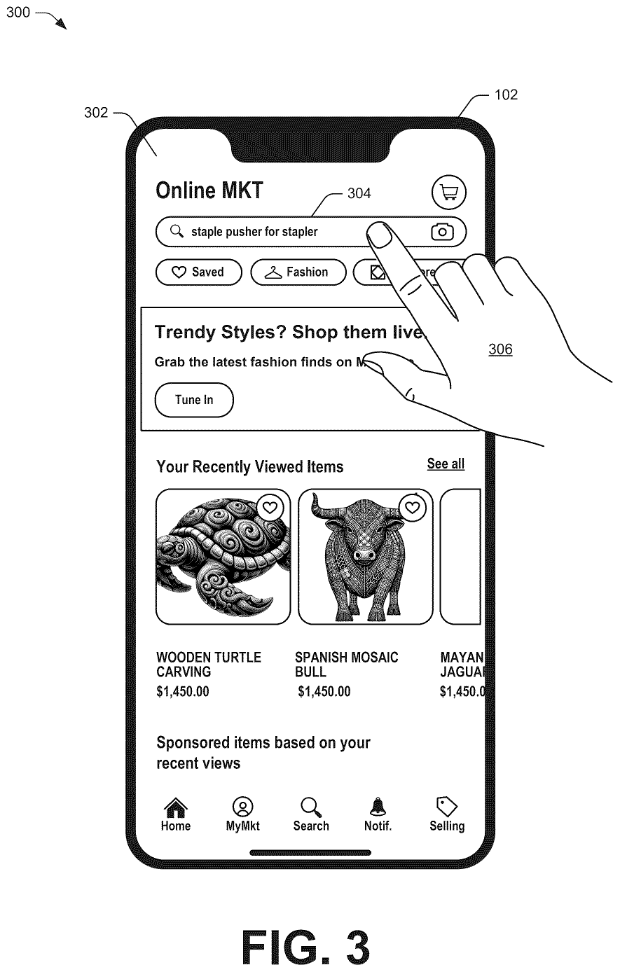

FIG. 3 depicts an example 300 of a browsing user interface of an online marketplace that includes an interactive search user interface element.

In this example 300, the computing device 102 is shown displaying a browsing user interface 302, e.g., of the online marketplace 112 presented by the application 110. The browsing user interface 302 may include various elements typically found in an online marketplace interface, such as navigation buttons, product categories, and recently viewed items.

The browsing user interface 302 also includes an interactive search element 304, which may be positioned near the top of the screen for easy access. This interactive search element 304 may allow users to input search queries for specific items or component parts they are looking for. In the illustrated example, a hand 306 of a user is shown interacting with the interactive search element 304, demonstrating how a user might engage with the search functionality of the interface. The interactive search element 304 may be designed to accept various types of input, including text, voice commands, or even image-based searches. In some implementations, the search element may incorporate autocomplete functionality or suggest popular searches as the user types. This may help users formulate more effective queries, potentially increasing the likelihood of finding relevant results, including assemblies that incorporate sought-after component parts.

When a user submits a search query through the interactive search element 304, the system may process the query and transition to a search results interface, as depicted in subsequent figures. This transition may involve sending the search query 122 and/or the search results 126 indicating the component part 124 is unavailable by itself on the online marketplace 112 to the unavailable component part system 106, which may then initiate the process of identifying relevant assemblies 136 that incorporate the searched-for component part 124, such as when the component part 124 is not available on the online marketplace 112 as a standalone item.

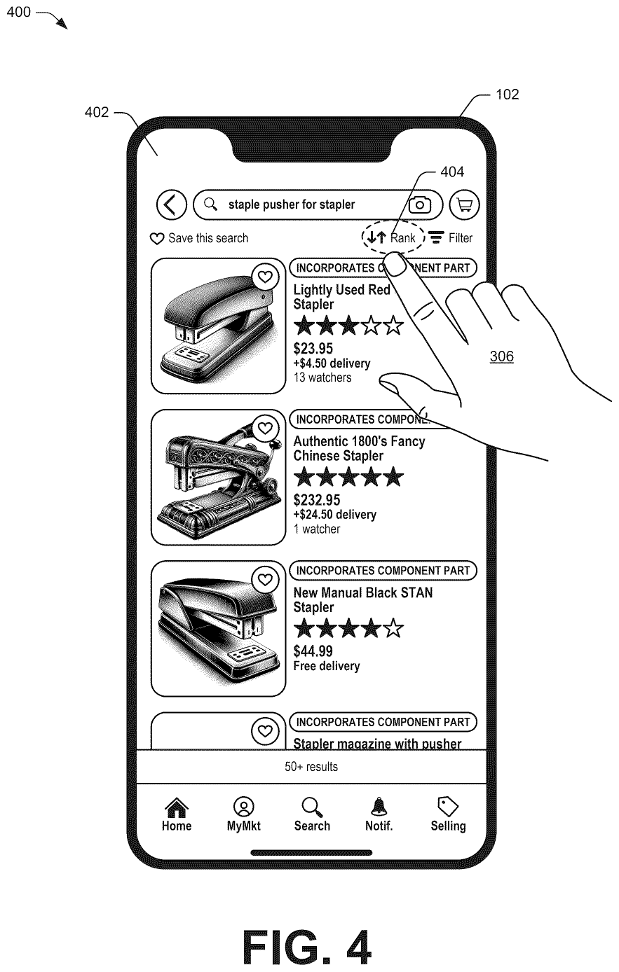

FIG. 4 depicts an example 400 of a search results user interface of an online marketplace.

In this example 400, the computing device 102 displays a search results user interface 402 of the online marketplace 112. The search results user interface 402 may present multiple listings. In the context of the described techniques, the search results user interface 402 may present one or more listings of assemblies 136 that incorporate the component part 124 which was specified in the initial search query 122. The presented listings may include an image of a respective assembly, a title, description, pricing information, and/or an indication that the assembly incorporates the searched-for component part.

In one or more implementations, the search results user interface 402 includes a launch ranking element 404. This interactive element may be designed to catch the user's attention and invite interaction. In the illustrated example, the hand 306 of the user is shown reaching towards the launch ranking element 404, suggesting that a user may interact with this element to access additional functionality related to ranking or sorting the search results.

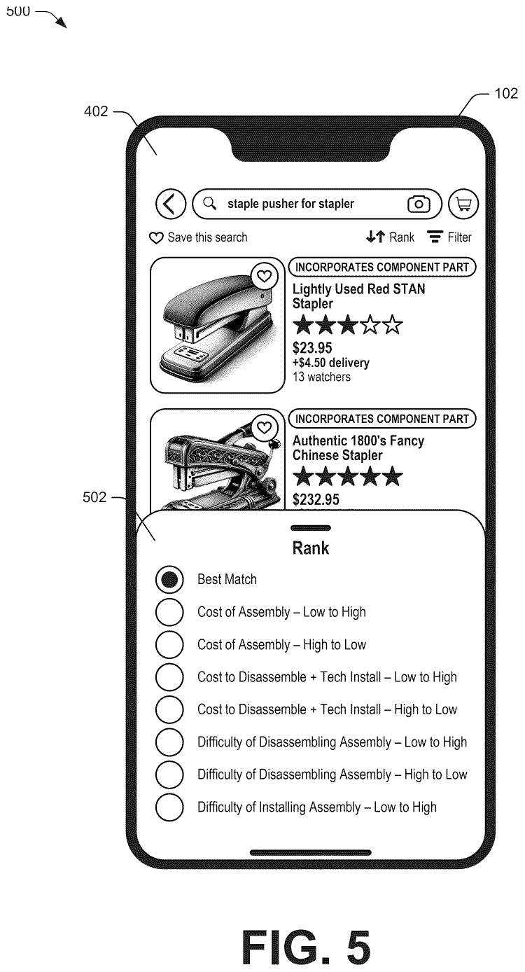

FIG. 5 depicts an example 500 of an interactive ranking user interface element being displayed from a search results user interface of an online marketplace.

The launch ranking element 404 may serve as an entry point to more advanced sorting and ranking options beyond basic criteria like price or relevance. When activated, this element may trigger the display of the interactive ranking element 502 shown in FIG. 5, allowing users to sort the assemblies based on factors specifically relevant to incorporating the desired component part 124. This functionality may help users make more informed decisions when selecting an assembly 136 that includes the component part 124, taking into account factors such as the cost or difficulty of accessing the specific part within the larger assembly.

The example 500 illustrates the search results user interface 402 displayed on the computing device 102. In accordance with at least one implementation, the search results user interface 402 also presents an interactive ranking element 502, offering users a range of options to rank or otherwise sort the displayed assembly listings. These ranking options may include criteria such as “Best Match,” “Cost of Assembly” (with options for both low to high and high to low), “Cost to Disassemble and Tech Install” (also with low to high and high to low options), “Difficulty of Disassembling Assembly” (again with both ordering options), and “Difficulty of Installing Assembly” (from low to high), to name just a few. By interacting with these ranking options, users may quickly reorganize the search results to prioritize assemblies based on factors most relevant to their specific needs, skills, or resources. This granular control over result presentation may enhance the user's ability to identify the most suitable assembly incorporating the desired component part, taking into account not just the availability of assemblies which include the component part but also practical considerations for obtaining and utilizing the component part.

Having discussed exemplary details of presenting an assembly incorporating an individually unavailable component part, consider now some examples of procedures to illustrate additional aspects of the techniques.

### Example Procedures

This section describes examples of procedures for presenting an assembly incorporating an individually unavailable component part. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

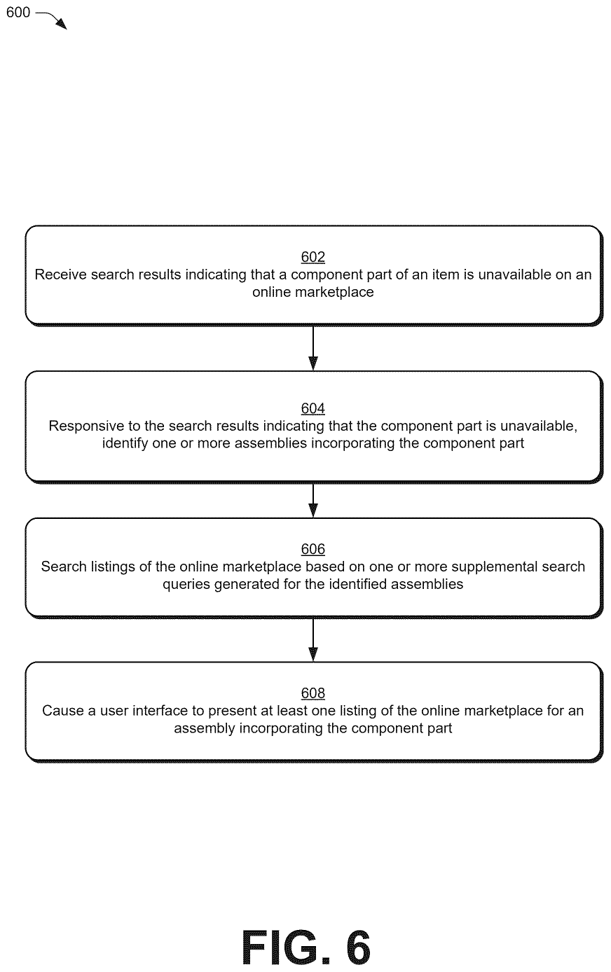

FIG. 6 depicts a procedure 600 in an example implementation of presenting an assembly incorporating an individually unavailable component part.

Search results indicating that a component part of an item is unavailable on an online marketplace are received (block 602). By way of example, the unavailable component part system 106 receives the search results 126 which indicate that there are no listings 118 available on the online marketplace 112 for the component part 124 as a standalone item. These search results 126 may be received responsive to a search engine searching the real-time listing data 116 for the component part 124 based on receipt of the search query 122 from the computing device 102.

Responsive to the search results indicating that the component part is unavailable, one or more assemblies incorporating the component part are identified (block 604). For example, the unavailable component part system 106 may utilize the large language model 130 to analyze the parts lists 206 and assembly tree structures 208 to identify assemblies 136 that incorporate the component part 124. The large language model 130 may generate one or more supplemental search queries 134 based on the identified assemblies 136.

Listings of the online marketplace are searched based on one or more supplemental search queries generated for the identified assemblies (block 606). In some implementations, the online marketplace 112 may receive the supplemental search queries 134 from the unavailable component part system 106 and use these queries to search the real-time listing data 116. The search may be performed by a search engine or search module of the online marketplace 112 to find listings 118 for assemblies 136 that incorporate the component part 124.

A user interface presents at least one listing of the online marketplace for an assembly incorporating the component part (block 608). For instance, the application 110 on the computing device 102 may display a search results user interface 402 that includes one or more listings 118 for assemblies 136 identified as incorporating the component part 124. The presented listings may include relevant information such as images, descriptions, pricing, and/or an indication that the assembly incorporates the searched-for component part 124. In some cases, the listings may be presented in a ranked order based on criteria such as cost, difficulty of disassembly, or other factors relevant to obtaining and utilizing the component part 124 from the assembly 136.

In one or more implementations, the online marketplace 112 may provide users with detailed instructions via a user interface for disassembly and/or installation. These instructions may describe at least one of how to disassemble an assembly 136 to obtain a component part 124 or how to install the component part 124 within the item for which the component part 124 is sought. The instructions may be presented in various formats, such as text, images, diagrams, or video tutorials. In some cases, the instructions may be tailored to the specific assembly 136 and component part 124 identified in the search results. The user interface may allow users to access these instructions directly from the assembly listing or through a dedicated section of the online marketplace 112. By providing such guidance, the system may assist users in successfully extracting the desired component part 124 from the assembly 136 and utilizing the part for an intended purpose.

In one or more implementations, the unavailable component part system 106 may identify and present one or more compatible parts for the component part 124, rather than identifying assemblies that incorporate the actual component part 124. In this approach, the unavailable component part system 106 may analyze the parts lists 206 and other relevant data to determine parts that are compatible with or can serve as substitutes for the unavailable component part 124. The large language model 130 may generate supplemental search queries 134 to search for compatible parts—rather than searching for assemblies which incorporate the component part—which may then be used to search the real-time listing data 116 of the online marketplace 112. The search results user interface 402 may present listings 118 for these compatible parts, potentially including information such as compatibility ratings, price comparisons with the original part, and user reviews of the substitute parts. This functionality may provide users with alternative options when the exact component part they are seeking is unavailable, potentially enabling them to complete their repair or replacement tasks without needing to purchase an entire assembly.

Having described examples of procedures in accordance with one or more implementations, consider now an example of a system and device that can be utilized to implement the various techniques described herein.

### Example System and Device

FIG. 7 illustrates an example of a system generally at 700 that includes an example of a computing device 702 that is representative of one or more computing systems and/or devices that may implement the various techniques described herein. This is illustrated through inclusion of the application 110 and the unavailable component part system 106. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 706 is illustrated as including memory/storage 712. The memory/storage 712 represents memory/storage capacity associated with one or more computer-readable media. The memory/storage 712 may include volatile media (such as random-access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

In some aspects, the techniques described herein relate to a computer-implemented method including: receiving, by at least one computing device, search results indicating that a component part of an item is unavailable on an online marketplace; responsive to the search results indicating that the component part is unavailable, identifying, by the at least one computing device, one or more assemblies incorporating the component part; searching, by the at least one computing device, listings of the online marketplace based on one or more supplemental search queries generated for the identified assemblies; and causing, by the at least one computing device, a user interface to present at least one listing of the online marketplace for an assembly incorporating the component part.

In some aspects, the techniques described herein relate to a computer-implemented method, further including: ranking the identified assemblies based on one or more criteria; and causing the user interface to present a listing of a highest-ranked assembly.

In some aspects, the techniques described herein relate to a computer-implemented method, wherein the identified assemblies are ranked based on at least one of: cost of an identified assembly from the identified assemblies; cost to disassemble the identified assembly and install the component part by a technician; difficulty of disassembling the identified assembly to obtain the component part; or difficulty of installing the identified assembly in the item.

In some aspects, the techniques described herein relate to a computer-implemented method, further including identifying the one or more assemblies incorporating the component part based on at least one of a repository of parts lists maintained for a plurality of assemblies or tree structures defining assemblies of items and at least one of sub-assemblies or parts of the assemblies.

In some aspects, the techniques described herein relate to a computer-implemented method, further including generating the one or more supplemental search queries using at least one large language model (LLM) fine-tuned based on at least one of the repository of parts lists or the tree structures, including formulating a prompt to elicit the one or more supplemental search queries from the LLM as output based on a search query for the component part.

In some aspects, the techniques described herein relate to a computer-implemented method, wherein the prompt to elicit the one or more supplemental search queries from the LLM is formulated based on a prompt template, wherein the prompt template includes one or more functions that are modifiable based on the component part and configured to cause a search of at least one of the repository of parts lists or the tree structures to identify the one or more assemblies incorporating the component part.

In some aspects, the techniques described herein relate to a computer-implemented method, wherein the tree structures include a tree structure corresponding to a different item from the item or the repository of parts lists includes a parts list corresponding to the different item, and the identified assemblies include an assembly of the different item.

In some aspects, the techniques described herein relate to a computer-implemented method, further including: searching listings of the online marketplace based on a supplemental search query for a compatible part; and causing the user interface to present at least one listing of the online marketplace for the compatible part.

In some aspects, the techniques described herein relate to a computer-implemented method, further including causing the user interface to present instructions describing at least one of how to disassemble the assembly to obtain the component part or install the component part.

In some aspects, the techniques described herein relate to a system including: one or more processors; and memory storing instructions that, when executed by the one or more processors, cause the system to perform operations including: receiving search results indicating that a component part of an item is unavailable on an online marketplace; responsive to the search results indicating that the component part is unavailable, identifying one or more assemblies incorporating the component part; searching listings of the online marketplace based on one or more supplemental search queries generated for the identified assemblies; and causing a user interface to present at least one listing of the online marketplace for an assembly incorporating the component part.

In some aspects, the techniques described herein relate to a system, wherein the operations further include: ranking the identified assemblies based on one or more criteria; and causing the user interface to present a listing of a highest-ranked assembly.

In some aspects, the techniques described herein relate to a system, wherein the identified assemblies are ranked based on at least one of: cost of an identified assembly from the identified assemblies; cost to disassemble the identified assembly and install the component part by a technician; difficulty of disassembling the identified assembly to obtain the component part; or difficulty of installing the identified assembly in the item.

In some aspects, the techniques described herein relate to a system, wherein the operations further include identifying the one or more assemblies incorporating the component part based on at least one of a repository of parts lists maintained for a plurality of assemblies or tree structures defining assemblies of items and at least one of sub-assemblies or parts of the assemblies.

In some aspects, the techniques described herein relate to a system, wherein the operations further include generating the one or more supplemental search queries using at least one large language model (LLM) fine-tuned based on at least one of the repository of parts lists or the tree structures, including formulating a prompt to elicit the one or more supplemental search queries from the LLM as output based on a search query for the component part.

In some aspects, the techniques described herein relate to a system, wherein the prompt to elicit the one or more supplemental search queries from the LLM is formulated based on a prompt template, wherein the prompt template includes one or more functions that are modifiable based on the component part and configured to cause a search of at least one of the repository of parts lists or the tree structures to identify the one or more assemblies incorporating the component part.

In some aspects, the techniques described herein relate to one or more computer-readable storage media including instructions stored thereon that, responsive to execution by one or more processors, perform operations including: receiving search results indicating that a component part of an item is unavailable on an online marketplace; responsive to the search results indicating that the component part is unavailable, identifying one or more assemblies incorporating the component part; searching listings of the online marketplace based on one or more supplemental search queries generated for the identified assemblies; and causing a user interface to present at least one listing of the online marketplace for an assembly incorporating the component part.

In some aspects, the techniques described herein relate to one or more computer-readable storage media, wherein the operations further include: ranking the identified assemblies based on one or more criteria; and causing the user interface to present a listing of a highest-ranked assembly.

In some aspects, the techniques described herein relate to one or more computer-readable storage media, wherein the operations further include identifying the one or more assemblies incorporating the component part based on at least one of a repository of parts lists maintained for a plurality of assemblies or tree structures defining assemblies of items and at least one of sub-assemblies or parts of the assemblies.

In some aspects, the techniques described herein relate to one or more computer-readable storage media, wherein the operations further include generating the one or more supplemental search queries using at least one large language model (LLM) fine-tuned based on at least one of the repository of parts lists or the tree structures, including formulating a prompt to elicit the one or more supplemental search queries from the LLM as output based on a search query for the component part.

In some aspects, the techniques described herein relate to one or more computer-readable storage media, wherein the operations further include: searching listings of the online marketplace based on a supplemental search query for a compatible part; and causing the user interface to present at least one listing of the online marketplace for the compatible part.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving, by at least one computing device, search results indicating that a component part of an item is unavailable on an online marketplace;
responsive to the search results indicating that the component part is unavailable, identifying, by the at least one computing device, one or more assemblies incorporating the component part;
searching, by the at least one computing device, listings of the online marketplace based on one or more supplemental search queries generated for the identified assemblies; and
causing, by the at least one computing device, a user interface to present at least one listing of the online marketplace for an assembly incorporating the component part.

2. The computer-implemented method of claim 1, further comprising:
ranking the identified assemblies based on one or more criteria; and
causing the user interface to present a listing of a highest-ranked assembly.

3. The computer-implemented method of claim 2, wherein the identified assemblies are ranked based on at least one of:
cost of an identified assembly from the identified assemblies;
cost to disassemble the identified assembly and install the component part by a technician;
difficulty of disassembling the identified assembly to obtain the component part; or
difficulty of installing the identified assembly in the item.

4. The computer-implemented method of claim 1, further comprising identifying the one or more assemblies incorporating the component part based on at least one of a repository of parts lists maintained for a plurality of assemblies or tree structures defining assemblies of items and at least one of sub-assemblies or parts of the assemblies.

5. The computer-implemented method of claim 4, further comprising generating the one or more supplemental search queries using at least one large language model (LLM) fine-tuned based on at least one of the repository of parts lists or the tree structures, including formulating a prompt to elicit the one or more supplemental search queries from the LLM as output based on a search query for the component part.

6. The computer-implemented method of claim 5, wherein the prompt to elicit the one or more supplemental search queries from the LLM is formulated based on a prompt template, wherein the prompt template includes one or more functions that are modifiable based on the component part and configured to cause a search of at least one of the repository of parts lists or the tree structures to identify the one or more assemblies incorporating the component part.

7. The computer-implemented method of claim 4, wherein the tree structures include a tree structure corresponding to a different item from the item or the repository of parts lists includes a parts list corresponding to the different item, and the identified assemblies include an assembly of the different item.

8. The computer-implemented method of claim 1, further comprising:
searching listings of the online marketplace based on a supplemental search query for a compatible part; and
causing the user interface to present at least one listing of the online marketplace for the compatible part.

9. The computer-implemented method of claim 1, further comprising causing the user interface to present instructions describing at least one of how to disassemble the assembly to obtain the component part or install the component part.

10. A system comprising:
one or more processors; and
memory storing instructions that, when executed by the one or more processors, cause the system to perform operations comprising:
receiving search results indicating that a component part of an item is unavailable on an online marketplace;
responsive to the search results indicating that the component part is unavailable, identifying one or more assemblies incorporating the component part;
searching listings of the online marketplace based on one or more supplemental search queries generated for the identified assemblies; and
causing a user interface to present at least one listing of the online marketplace for an assembly incorporating the component part.

11. The system of claim 10, wherein the operations further comprise:
ranking the identified assemblies based on one or more criteria; and
causing the user interface to present a listing of a highest-ranked assembly.

12. The system of claim 11, wherein the identified assemblies are ranked based on at least one of:
cost of an identified assembly from the identified assemblies;
cost to disassemble the identified assembly and install the component part by a technician;
difficulty of disassembling the identified assembly to obtain the component part; or
difficulty of installing the identified assembly in the item.

13. The system of claim 10, wherein the operations further comprise identifying the one or more assemblies incorporating the component part based on at least one of a repository of parts lists maintained for a plurality of assemblies or tree structures defining assemblies of items and at least one of sub-assemblies or parts of the assemblies.

14. The system of claim 13, wherein the operations further comprise generating the one or more supplemental search queries using at least one large language model (LLM) fine-tuned based on at least one of the repository of parts lists or the tree structures, including formulating a prompt to elicit the one or more supplemental search queries from the LLM as output based on a search query for the component part.

15. The system of claim 14, wherein the prompt to elicit the one or more supplemental search queries from the LLM is formulated based on a prompt template, wherein the prompt template includes one or more functions that are modifiable based on the component part and configured to cause a search of at least one of the repository of parts lists or the tree structures to identify the one or more assemblies incorporating the component part.

16. One or more computer-readable storage media comprising instructions stored thereon that, responsive to execution by one or more processors, perform operations comprising:
receiving search results indicating that a component part of an item is unavailable on an online marketplace;
responsive to the search results indicating that the component part is unavailable, identifying one or more assemblies incorporating the component part;
searching listings of the online marketplace based on one or more supplemental search queries generated for the identified assemblies; and
causing a user interface to present at least one listing of the online marketplace for an assembly incorporating the component part.

17. The one or more computer-readable storage media of claim 16, wherein the operations further comprise:
ranking the identified assemblies based on one or more criteria; and
causing the user interface to present a listing of a highest-ranked assembly.

18. The one or more computer-readable storage media of claim 16, wherein the operations further comprise identifying the one or more assemblies incorporating the component part based on at least one of a repository of parts lists maintained for a plurality of assemblies or tree structures defining assemblies of items and at least one of sub-assemblies or parts of the assemblies.

19. The one or more computer-readable storage media of claim 18, wherein the operations further comprise generating the one or more supplemental search queries using at least one large language model (LLM) fine-tuned based on at least one of the repository of parts lists or the tree structures, including formulating a prompt to elicit the one or more supplemental search queries from the LLM as output based on a search query for the component part.

20. The one or more computer-readable storage media of claim 16, wherein the operations further comprise:
searching listings of the online marketplace based on a supplemental search query for a compatible part; and
causing the user interface to present at least one listing of the online marketplace for the compatible part.
